(19) United States
(12) Patent Application Publication
(10) Pub. No.: US 2005/0171795 A1
(43) Pub. Date: Aug. 4, 2005

(54) Media receipt device and system and a method of using the same

(76) Inventors: Gerald W. Kearby, Loma Mar, CA (US); Earl I. Levine, Palo Alto, CA (US)

Correspondence Address: DAVID A. LEVINE, P. O. BOX 61180, PALO ALTO, CA, 94306-1180, US

(21) Appl. No.: 10/770,086

(22) Filed: Jan. 31, 2004

(51) Int. Cl. G06F 17/60

(52) U.S. Cl. 705/1

(57) ABSTRACT

A method and system for delivering data of a performance to audience members is disclosed. Delivery devices can be transferred to the audience members following the performance. The delivery devices can have redeemers, for example, unique codes. The audience members can use the unique codes to later download the performance and transfer it onto the delivery devices.

### BACKGROUND OF THE INVENTION

1. Field of the Invention

The present invention relates to the field of data distribution and, more specifically, to the field of downloadable multimedia.

2. Description of the Related Art

On-site distribution of artists' work immediately following a performance is a popular point of sale. With the reduction of cost and portability of many recordable forms of media and their associated recording equipment, such as compact discs and compact disc recorders or “burners”, the performance that audience members just witnessed can be rapidly manufactured and sold to the departing audience members immediately following the performance.

Unfortunately, for many performances, high demand for such recordings by the departing audience causes logistical problems for the production and distribution of the media. The level of demand is a function of audience members in attendance. Attendance can exceed 100,000 audience members for many live performances such as sports events and music concerts.

Media recording equipment can only record up to a given speed. Also, many media types can only begin recording after the performance has ended. Furthermore, the performance itself may need to be processed before recording, for example when mixing or mastering audio works.

To compensate for these deficiencies, large quantities of recording equipment must be moved to the performance site and, even then, recording sufficient quantities of media to satisfy the audience demand can take an excessively long time. The delay in production of the final recorded product often causes long queues of audience members waiting to purchase freshly recorded media. This is often the biggest bottleneck in the sale of performances to their respective departing audiences. Many audience members who would otherwise purchase the performance as they departed the performance instead opt out of waiting in line and never purchase the performance in the future. Sales to those audience members must be made at the time of audience departure.

Extra employees are also needed on-site to produce the recorded media. The skill set needed to manufacture the large quantity of recorded media is often not held by the typical employees on-site at performances. Thus, large quantities of specialized employees must be present. Additionally, under such time constraints and with large lines of potential customers, these employees make an increased number of errors in both the production and sale of the media. This can effect the quality of master recordings and overall customer satisfaction.

Therefore there exists a need for a method and system to sell performance recordings to the departing audience from the performance at the time of the audience's departure. Furthermore, there exists a need for a device on which the performance can be delivered to the departing audience. There also exists a need to deliver the performance to the audience on media after the audience has fully departed the performance venue and/or after the performance has been properly processed.

### BRIEF SUMMARY OF THE INVENTION

A receiving device for receiving data is disclosed. The device has a medium container. The medium container has a data redeemer. The data can include an audio performance. The data can include a visual performance. The medium container can be a jewel case. The device can also have a medium that associates with the medium container. The medium can be a compact disc. The medium can be a digital video disc.

Furthermore, a data distribution system is disclosed. The data distribution system has a first medium container and a second medium container. The first medium container has a first medium redeemer. The second medium container has a second medium redeemer. The first medium redeemer is unique from the second medium redeemer.

A method of delivering data is also disclosed. The method includes distributing a first medium container. The first medium container has a first medium redeemer. The method also includes delivering the data when the redeemer is redeemed.

The redeemer can include a redemption code. The redeemer can be activated when the first medium container is distributed. The redeemer can be activated before the first medium container is distributed. Redeeming the redeemer can include validating the redeemer. Delivering can include transferring from a remote storage medium to a local storage medium.

### BRIEF DESCRIPTION OF THE DRAWINGS

FIG. 1 illustrates an embodiment of the receiving device.

FIG. 2 illustrates an embodiment of the method for delivering the data.

### DETAILED DESCRIPTION

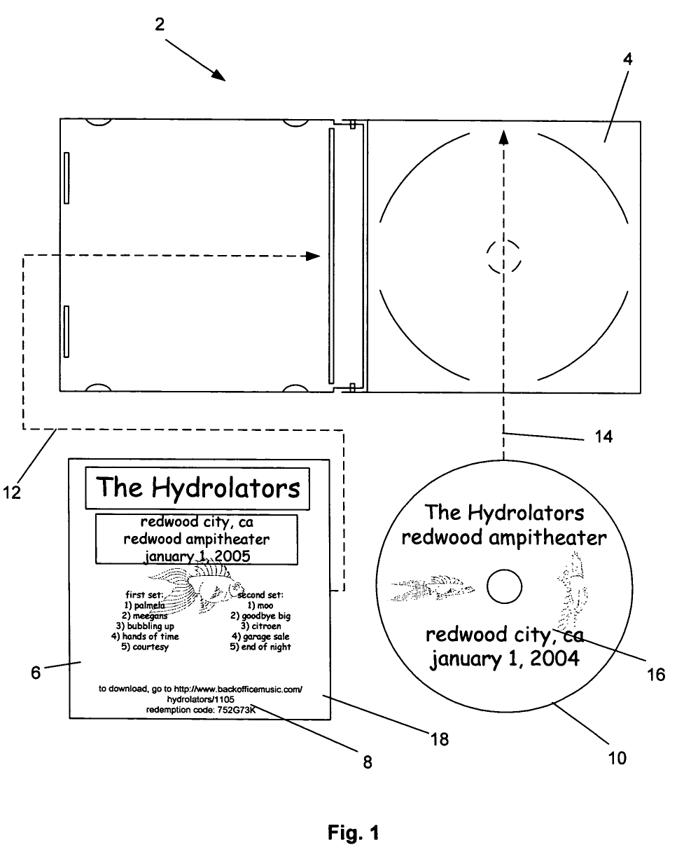

FIG. 1 illustrates a receiving device 2 for receiving data, for example data of a performance (e.g., music or theatrical performance, sporting event, academic lecture) to an audience member following the performance. The receiving device 2 is shown in FIG. 1 in an open configuration. The receiving device 2 can have a medium container 4, a medium container label 6, a redeemer 8, and a medium 10.

The medium container 4 can be ajewel case for one or more compact discs (CDs) or digital video discs (DVDs), an envelope (e.g., paper, cardboard, plastic) for one or more CDs or DVDs, a video tape case, an audio tape case, or combinations thereof.

The medium container label 6 can be a label properly sized to fit in or on the medium container 4, such as a jewel case booklet or single sheet, a silk-screened label or other label printed directly onto the medium container 4, an adhesive label, or combinations thereof. If the medium container label 6 is separate from the medium container 4, the medium container label 6 can be fixedly or removably attached to the medium container 4 as shown by arrow 12.

The medium can be a CD (e.g., a CD-R, a CD-RW), DVD (e.g., recordable DVD, DVD-audio), digital audio tape (DAT), magnetic audio tape, magnetic video tape (e.g., VHS format, Betamax format), flash memory, or combinations thereof. The medium 10 can be associated with the medium container 4, such as when the medium container 4 is constructed with dimensions to hold the medium 10. The medium 10 can be physically unlabeled, physically labeled (e.g., with an adhesive, etched, printed, sand or otherwise blasted, or silk-screened label), come with a physical label (e.g., an unattached adhesive label) to be optionally attached to the medium 10 by the user, or combinations thereof. The medium 10 can be blank (i.e., void of pre-recorded data), or can be partially or completely pre-recorded (e.g., with greatest hits, previous performances, formatting, computer programs/applications). The medium 10 can be removably attached to the medium container 4 as shown by arrow 16. The medium 10 can have a medium label 16, for example, a silk-screened label or other label printed directly onto the medium container 4, an adhesive label, or combinations thereof.

The medium container label 6 and/or the medium label 16 can have instructions 18 on how to redeem the redeemer 8 and retrieve the data and/or other information (e.g., regarding the performance and/or artists, artwork).

The redeemer 8 can have a redemption code, for example, a printed alphanumeric sequence such as a random sequence or a unique URL (e.g., directly printed onto the medium 10, a label 6 and/or 16 or, for example, on a separate paper or card), magnetically recorded data (e.g., on a magnetic stripe on a card, like a credit card device) such as an alphanumeric sequence, for example a binary number or numbers (e.g., in hexadecimal form), or a series of electrical, magnetic, or radio frequency (RF) outputs based on a given input (e.g., a smart card or other device with a microprocessor or RAM), or combinations thereof. The redeemer 8 can have a redemption code in a physical configuration (e.g., a token or physical key). The redeemer 8 can be an analog or digital code, for example, optically, RF, or othrwise transferred into a mobile device such as a portable phone, laptop computer or personal data assistant (PDA).

The redeemer 8 can also be hidden from view and/or detection before the medium container 4 is opened by the user. For example, the redeemer 8 can be printed on the inside of the medium container 4 and/or covered by a visually opaque and/or magnetically opaque removably attached label.

The receiving device 2 can have an activator (not shown). The activator can be an activation code in a form disclosed supra for the redeemer 8. The activator can be visible and/or detectable before the medium container 4 is opened by the user. The activation code can be cryptographically related to the redemption code.

### SYSTEM AND METHOD OF USE

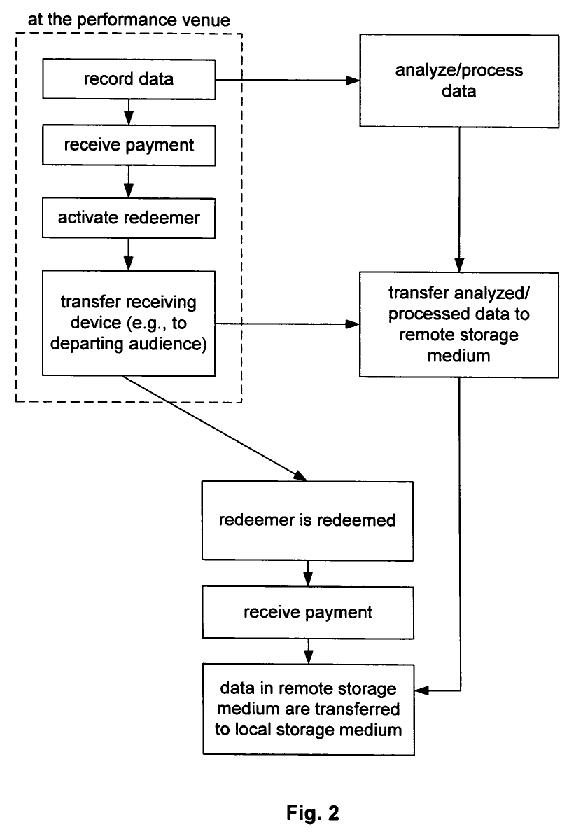

FIG. 2 illustrates a method of delivering the data using the data receiving device 2. The data, for example the aforementioned performance, can be recorded. Once the data is recorded, the receiving device 2 can be transferred to the end user, for example by physically handing to or otherwise delivering the receiving device 2 to a departing audience member.

The price of the receiving device 2 can be received in its entirety at the time of the purchase and/or transfer of the receiving device 2, or at the time of use of the redemption code of the redeemer 8, or at the beginning, middle and/or completion of the transfer of the data, or separately in combinations thereof (e.g., one-third of the price can be paid separately at the purchase, the use of the redeemer, and the transfer of the data).

The data to be delivered can be prepared before delivery to the receiving device 2. This preparation can be, for example, recording and processing and/or analyzing the performance. The processing and/or analyzing can include mixing, mastering, converted into a format, for example, a standard motion video, audio, or still video format (e.g., MPEG, DVD (e.g., MPEG2 video codec with AC-3 audio codec), WMV, AVI, MP3, redbook, AAC, AC-3, ATRAC2, ATRAC3, MPEG4 audio and/or video, AIFF, WMA, MIDI, WAV, AU, ASF, JPG, ogg vorbis, GIF, Tag Image File (TIF), postscript, PICT, bitmap), adding labels (e.g., titles, ID3 tags), concatenating or dividing files or combinations thereof. The data can be transferred to a remote storage medium, for example, a hard drive on a networked server.

The user (e.g., the ex-audience member) can redeem the redeemer. Redeeming the redeemer grants permission to the user to transfer the data from the remote storage medium to a local storage medium. The instructions 18 can direct users to a redemption location, for example, a server at a URL or a kiosk computer. Once the redemption location is accessed, the redeemer 8 (e.g., the redemption code) can be submitted to the redemption location for validation.

All redeemers 8 distributed for a specific data set (e.g., a single performance or all performances by one artist) can have the same redemption code or different (e.g., absolutely individually unique, or sets of unique) redemption codes. The redemption code(s) can be activated or deactivated after a specific date (e.g., one month after the date of the performance) or can be active perpetually. Before transfer, during transfer or after transfer of the receiving device 2, the redemption code can be activated.

The redemption code can be activated by being directly recorded and activated. The redemption code can be barcoded and/or alphanumerically printed on the medium container 4. The redemption codes assigned to receiving devices 2 that have been transferred to users can then be activated. All redemption codes can be pre-enabled and then redemption codes remaining on non-sold inventory can be deactivated or inventory can be destroyed or distributed at a later time.

The redemption code can be indirectly activated, for example by activating the activator. The activator can be activated by any method disclosed supra for activating redemption codes.

Activating a specific redemption code enables the redeemer(s) 8 bearing that redemption code to receive permission to the user to transfer the data from the remote storage medium to a local storage medium. A database of activated redemption codes can be checked before permission is granted to use the redeemer 8.

The redemption codes and/or activation codes can have a digital signature. Digital cryptography can be used to verify the authenticity of the redemption code and/or the authenticity of the combination of the activation code and the redemption code. Methods of digital cryptography are known to those having ordinary skill in the art. For example, public-private key cryptography and/or a one-way hash function can be used.

If the redeemer 8 is being redeemed over a network, the network address (e.g., IP address) of the user's computer can be recorded. The transfer of the data from the remote storage medium to the local storage medium can be restricted to only allow transfer to the network address originally recorded when permission to transfer the data is granted.

Transfers with a single redemption code can be limited in quantity. For example, a single redeemer can be allowed to transfer a maximum number of data files at one time (e.g., three files at once) or within a specific time interval (e.g., ten files per day). Multiple downloads of the same data can be restricted from a single redemption code. Transfers can be required to occur within a specific amount of time (e.g., one week) after the redeemer 8 has been granted permission to transfer the data. Total transfers from all users can also be limited (e.g., to maintain a maximum transfer bandwidth).

Once the redeemer 8 has been granted permission to transfer the data from the remote storage medium, the data can be transferred to the local storage medium. The local storage medium can be a home computer (e.g., a local hard drive, the medium 10, or another medium as listed supra as an example for the medium 10), a networked drive, and/or a kiosk computer (e.g., at a music store or at the performance site). The redeemer 8 can also be used to retrieve the data, perhaps already on a local storage medium, from personnel, for example a clerk at a store. The redeemer 8 can be used to order pre-recorded data online (e.g., through a retailer). The redeemer 8 can be used to retrieve the data on a peer-to-peer network, or combinations of the redemptions supra.

The transfer from the remote storage medium to the local storage medium can be, for example, a download and/or stream. Downloading can be defined as retrieving a copy of an entire data file from remote storage to a local storage medium. Downloading includes direct recording (e.g., a kiosk computer recording a CD). Streaming can be defined as the display or other playback or execution of the media in parallel with the copying of the media from the remote storage location to the local storage location, perhaps with a short delay between the copying and the playback or execution.

Once the user has the data on a local storage device, the user can then transfer the data onto the medium 10 or a similar medium and store the medium 10 in the medium container 4.

It is apparent to one skilled in the art that various changes and modifications can be made to this disclosure, and equivalents employed, without departing from the spirit and scope of the invention. Elements, configurations of elements, actions, and the order of actions shown with any embodiment are exemplary for the specific embodiment and can be used on other embodiments and in other configurations and orders within this disclosure.

1. A device for receiving data comprising:
a medium container, wherein the media container comprises a data redeemer.

2. The device of claim 1, wherein the redeemer is used to access the data.

3. The device of claim 1, wherein the data comprises an audio performance.

4. The device of claim 3, wherein the data comprises a visual performance.

5. The device of claim 4, wherein the data comprises a computer application.

6. The device of claim 1, wherein the medium container comprises a jewel case.

7. The device of claim 1, wherein the medium container comprises a label.

8. The device of claim 1, further comprising a medium that associates with the medium container.

9. The device of claim 8, wherein the medium comprises a compact disc.

10. The device of claim 8, wherein the medium comprises a digital video disc.

11. The device of claim 8, wherein the medium comprises a label.

12. The device of claim 1, wherein the redeemer comprises a redemption code.

13. The device of claim 12, wherein the redemption code is used to access the data.

14. A data distribution system comprising:
a first a medium container, wherein the first media container comprises a first media redeemer, and
a second medium container, wherein the second media container comprises a second media redeemer, and
wherein the first media redeemer is unique from the second media redeemer.

15. A method of delivering data comprising:
distributing a first a medium container, wherein the first medium container comprises a first medium redeemer, and
delivering the data when the redeemer is redeemed.

16. The method of claim 15, wherein the redeemer comprises a redemption code.

17. The method of claim 15, further comprising activating the redeemer when the first medium container is distributed.

18. The method of claim 15, further comprising activating the redeemer before the first medium container is distributed.

19. The method of claim 15, wherein redeeming the redeemer comprises validating the redeemer.

20. The method of claim 15, wherein delivering comprises transferring from a remote storage medium to a local storage medium.

21. The method of claim 20, wherein transferring occurs over a network.

22. The method of claim 21, wherein transferring comprises downloading.

23. The method of claim 21, wherein transferring comprises streaming.

24. The method of claim 15, wherein the data comprises an audio file.

25. The method of claim 24, wherein the data comprises a video file.

26. The method of claim 25, wherein the data comprises a computer application.
